(19) United States
(12) Patent Application Publication
(10) Pub. No.: US 2009/0314650 A1
(43) Pub. Date: Dec. 24, 2009

(54) PROCESS OF PACKAGE SUBSTRATE

(75) Inventors: Tzyy-Jang Tseng, Hsinchu (TW); Chung W. Ho, Hsinchu (TW)

Correspondence Address: J C PATENTS, 4 VENTURE, SUITE 250, IRVINE, CA, 92618, US

(73) Assignee: SUBTRON TECHNOLOGY CO. LTD., Hsinchu (TW)

(21) Appl. No.: 12/422,432

(22) Filed: Apr. 13, 2009

(30) Foreign Application Priority Data
Jun. 19, 2008 (TW) 97122869

(51) Int. Cl. C25D 5/00; B05D 5/12

(52) U.S. Cl. 205/205; 427/58

(57) ABSTRACT

A process of a package substrate is provided. A plurality of metal layers stacked in sequence is used as a foundation structure. A thick heat conductive core is fabricated from one of the metal layers for providing high heat dissipation capability, and a plurality of pads is fabricated from another one of the metal layers for electrically connecting an electronic package at the next level.

### CROSS-REFERENCE TO RELATED APPLICATION

This application claims the priority benefit of Taiwan application serial no. 97122869, filed Jun. 19, 2008. The entirety of the above-mentioned patent application is hereby incorporated by reference herein and made a part of specification.

### BACKGROUND OF THE INVENTION

1. Field of the Invention

The present invention generally relates to a process of a package substrate.

2. Description of Related Art

The conventional quad flat no-lead (QFN) package is an electronic packaging technique broadly applied to integrated circuit (IC) chips which have few electrodes and require high heat dissipation. The pads of a QFN package do not extend out of the contour of the QFN package, and heat can be easily conducted to a next level package, such as a printed circuit board (PCB), through a plurality of pads distributed on the bottom of the QFN package. As described above, a conventional QFN package is usually fabricated on a single metal layer.

The wide spread of portable electronic products results in the increase of electrode numbers of IC chips originally packaged through the QFN packaging technique, and accordingly the conventional QFN packaging technique cannot provide sufficient pad number to meet the requirement of the IC chips having more electrodes. Thus, the pads originally arranged peripherally in a QFN package have to be arranged into an array in order to fulfill the electrode number of aforementioned IC chip, and at the same time, the high heat dissipation capability of the QFN package has to be maintained.

### SUMMARY OF THE INVENTION

Accordingly, the present invention is directed to a package substrate process which can produce a package substrate having a plurality of pads arranged as an array on the bottom thereof.

The present invention provides a package substrate process. A first metal layer, a second metal layer, and a third metal layer are provided, wherein the second metal layer is between the first metal layer and the third metal layer. The first metal layer is patterned to form a first patterned metal layer and expose part of the surface of the second metal layer. A dielectric layer is formed in the spaces surrounded by the first patterned metal layer, and the dielectric layer covers the exposed surface of the first patterned metal layer. At least one opening is formed, wherein the opening is located in the dielectric layer and exposes part of the surface of the first patterned metal layer. A conductive blind via is formed in the opening. A fourth metal layer is formed, wherein the fourth metal layer covers the exposed surface of the dielectric layer. The fourth metal layer is patterned to form a fourth patterned metal layer.

The third metal layer is patterned to form a third patterned metal layer. The second metal layer is patterned to form a second patterned metal layer.

A first patterned solder mask layer is formed, wherein the first patterned solder mask layer covers the exposed surface of the dielectric layer and part of the exposed surface of the fourth patterned metal layer.

A second patterned solder mask layer is formed, wherein the second patterned solder mask layer covers the exposed surface of the second patterned metal layer and part of the exposed surface of the third patterned metal layer.

The present invention further provides a package substrate process. A first metal layer, a second metal layer, and a third metal layer are provided, wherein the second metal layer is between the first metal layer and the third metal layer. The first metal layer is patterned to form a first patterned metal layer and expose a part of the surface of the second metal layer. A first dielectric layer is formed in the space surrounded by the first patterned metal layer, and the first dielectric layer covers the exposed surface of the first patterned metal layer. The second metal layer and the third metal layer are patterned to form a second patterned metal layer and a third patterned metal layer and expose part of the surface of the first patterned metal layer. A second dielectric layer is formed in the spaces surrounded by the second patterned metal layer and the third patterned metal layer. At least one through hole is formed, wherein the through hole passes through the first dielectric layer, the first patterned metal layer, and the second dielectric layer. A conductive through hole is formed in the through hole. At least one first opening is formed, wherein the first opening is located in the first dielectric layer and exposes part of the surface of the first patterned metal layer. A first conductive blind via is formed in the first opening. A fourth metal layer is formed, wherein the fourth metal layer covers the exposed surface of the first dielectric layer. A fifth metal layer is formed, wherein the fifth metal layer covers the exposed surface of the second dielectric layer. The fourth metal layer is patterned to form a fourth patterned metal layer. The fifth metal layer is patterned to form a fifth patterned metal layer. A first patterned solder mask layer is formed, wherein the first patterned solder mask layer covers the exposed surface of the first dielectric layer and part of the exposed surface of the fourth patterned metal layer. A second patterned solder mask layer is formed, wherein the second patterned solder mask layer covers part of the exposed surface of the third patterned metal layer and part of the exposed surface of the fifth patterned metal layer.

In the present invention, a plurality of metal layers stacked in sequence is used as a foundation structure for fabricating a package substrate, and a thick heat conductive core is fabricated from one of the metal layers to provide high heat dissipation capability, and a plurality of pads is fabricated from another one of the metal layers for electrically connecting an electronic package at the next level.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A-1J illustrate a package substrate process according to an embodiment of the present invention.

FIGS. 2A-2K illustrate a package substrate process according to another embodiment of the present invention.

FIG. 2L illustrates a circuit substrate in FIG. 2K applied in a chip package.

FIGS. 3A-3K illustrate a package substrate process according to yet another embodiment of the present invention.

FIG. 3L illustrates a circuit substrate in FIG. 3K applied in a chip package.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

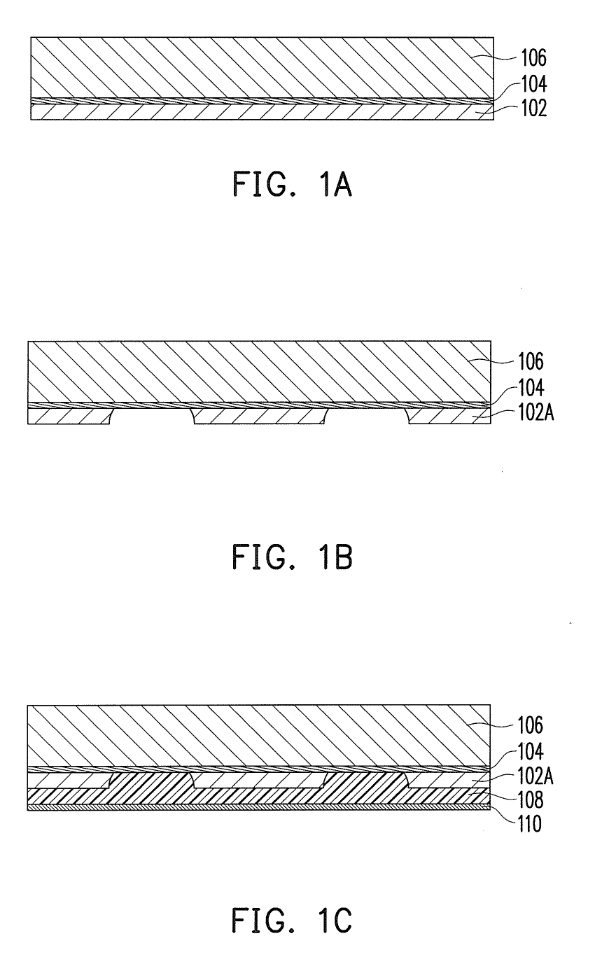

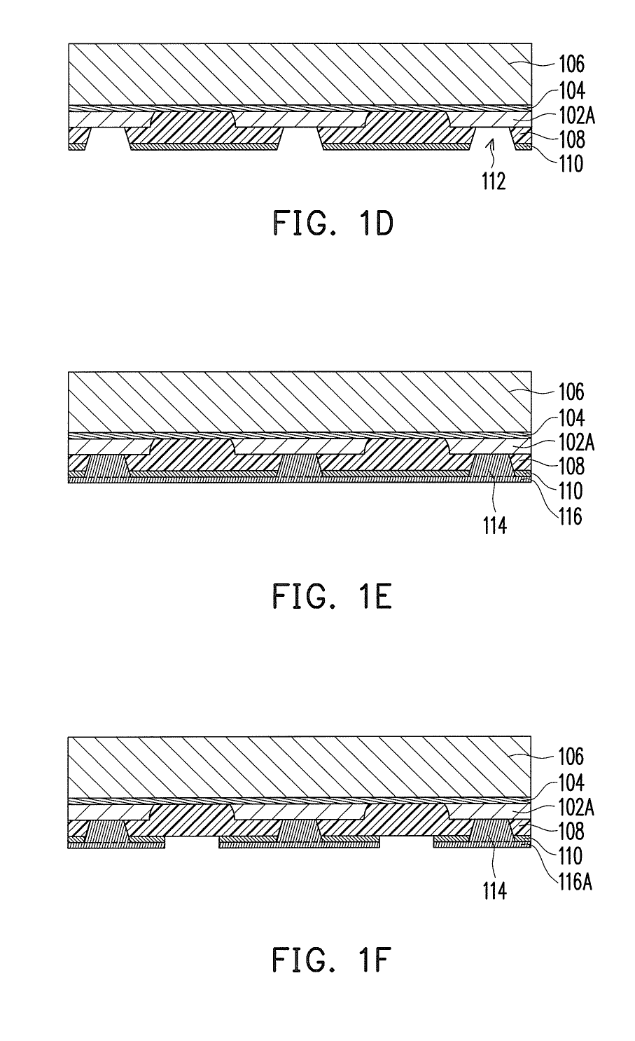

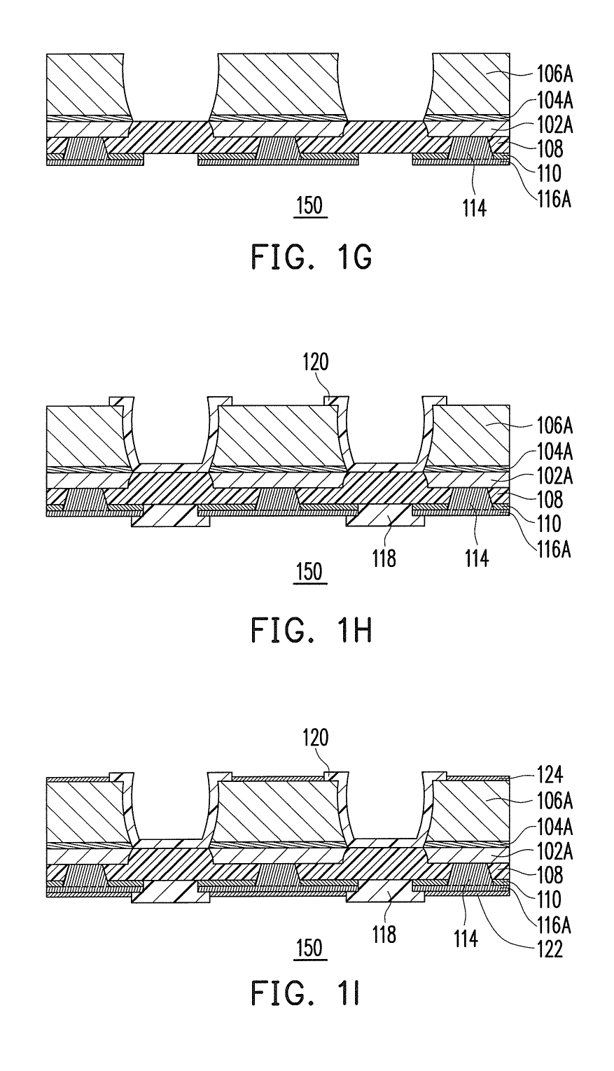

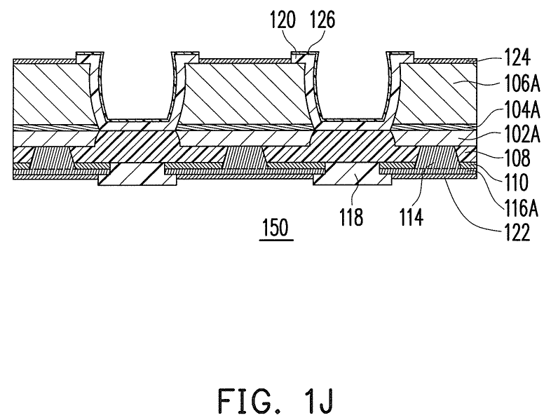

An embodiment of the present invention regarding a package substrate process will be described below with reference to FIGS. 1A-1J.

Referring to FIG. 1A, a first metal layer 102, a second metal layer 104, and a third metal layer 106 are provided, wherein the second metal layer 104 is between the first metal layer 102 and the third metal layer 106. In the present embodiment, the first metal layer 102 may be a copper layer having its thickness between 12 μm and 50 μm, the second metal layer 104 may be a nickel layer having its thickness between 0.1 μm and 2 μm, and the third metal layer 106 may be a copper layer having its thickness between 50 μm and 400 μm.

The second metal layer 104 separates the third metal layer 106 and the first metal layer 102 so that when the metal layers 102 and 106 are respectively etched, the etchant will not penetrate the second metal layer 104 to damage the other metal layer 102 or 106.

Referring to FIG. 1B, the first metal layer 102 in FIG. 1A is patterned to form a first patterned metal layer 102A and expose part of the surface of the second metal layer 104.

Referring to FIG. 1C, a dielectric layer 108 is formed in the spaces surrounded by the first patterned metal layer 102A, and the dielectric layer 108 also covers the exposed surface of the first patterned metal layer 102A. In the present embodiment, the step for forming the dielectric layer 108 includes following steps. First, a resin coated copper (RCC) is provided, wherein the RCC includes a resin layer and a copper foil 110 covering one surface of the resin layer. Next, the resin layer is thermo-compressed to be filled into the spaces surrounded by the first patterned metal layer 102A and the second metal layer 104, and covers the exposed surface of the first patterned metal layer 102A. By now, the dielectric layer 108 is formed.

Referring to FIG. 1D, at least one opening 112 is formed, wherein the opening 112 is located in the dielectric layer 108 and exposes part of the surface of the first patterned metal layer 102A. In the present embodiment, the opening 112 may be formed through laser ablation. Besides, the opening 112 is further located in the copper foil 110.

Referring to FIG. 1E, a conductive blind via 114 is formed in the opening 112. In the present embodiment, the conductive blind via 114 is formed through an electroplating process.

Referring to FIG. 1E again, a fourth metal layer 116 is formed, wherein the fourth metal layer 116 covers the copper foil 110. However, in another embodiment of the present invention, the fourth metal layer 116 can directly cover the exposed surface of the dielectric layer 108 when the copper foil 110 is skipped. In the present embodiment, the conductive blind via 114 and the fourth metal layer 116 can be formed together through an electroplating process.

Referring to FIG. 1F, the fourth metal layer 116 is patterned to form a fourth patterned metal layer 116A. In the present embodiment, the copper foil 110 can be patterned while the fourth metal layer 116 is patterned.

Referring to FIG. 1G, the third metal layer 106 is patterned to form a third patterned metal layer 106A. Next, the second metal layer 104 is patterned to form a second patterned metal layer 104A. It should be noted that because of the difference of materials between the first metal layer 102 and the second metal layer 104, the first patterned metal layer 102A is not removed when the second metal layer 104 is patterned.

Referring to FIG. 1H, a first patterned solder mask layer 118 is further formed, wherein the first patterned solder mask layer 118 covers the exposed surface of the dielectric layer 108, part of the exposed surface of the copper foil 110, and part of the exposed surface of the fourth patterned metal layer 116A. In addition, a second patterned solder mask layer 120 may be further formed, wherein the second patterned solder mask layer 120 covers the exposed surface of the second patterned metal layer 104A and part of the exposed surface of the third patterned metal layer 106A. Herein, the structure illustrated in FIG. 1H can already serve as a package substrate 150.

Referring to FIG. 1I, a first metal surface terminal metallurgy layer 122 is further formed, wherein the first metal surface terminal metallurgy layer 122 covers the exposed surface of the fourth patterned metal layer 116A. In addition, a second metal surface terminal metallurgy layer 124 may also be formed, wherein the second metal surface terminal metallurgy layer 124 covers the exposed surface of the third patterned metal layer 106A. In the present embodiment, the first metal surface terminal metallurgy layer 122 and the second metal surface terminal metallurgy layer 124 may be nickel-gold composite layers.

Referring to FIG. 1J, a reflecting layer 126 may be further formed, wherein the reflecting layer 126 covers the exposed surface of the second patterned solder mask layer 124. Thus, when a light emitting diode (LED) chip is packaged into the package substrate 150, the reflecting layer 126 can reflect the light emitted by the LED chip and accordingly the optical efficiency can be improved.

The embodiment illustrated in FIGS. 1A-1I can be applied to a quad flat no-lead (QFN) package and provide pads arranged as an array.

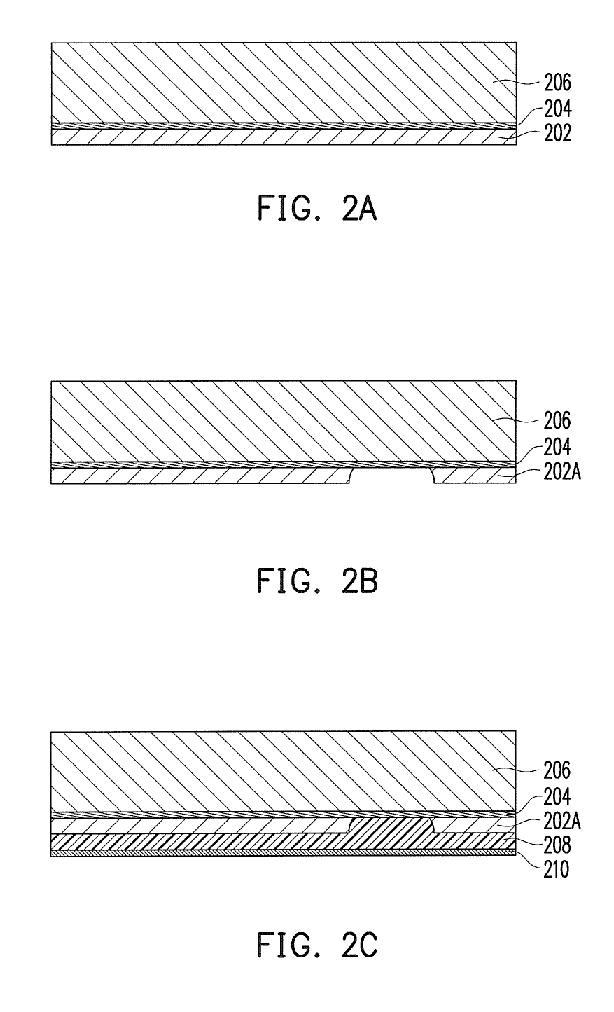

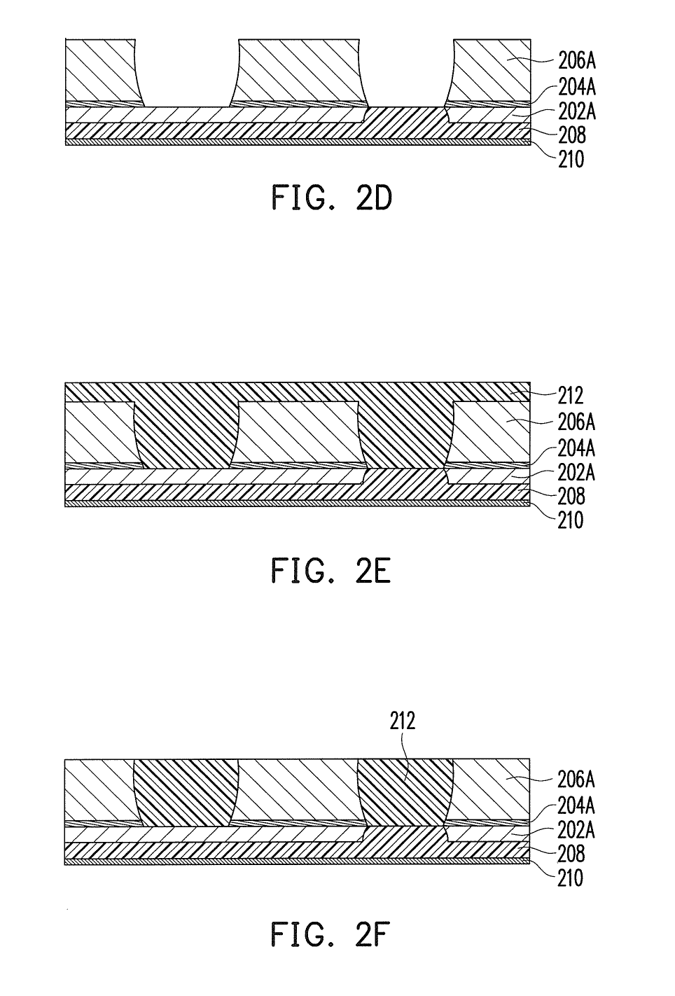

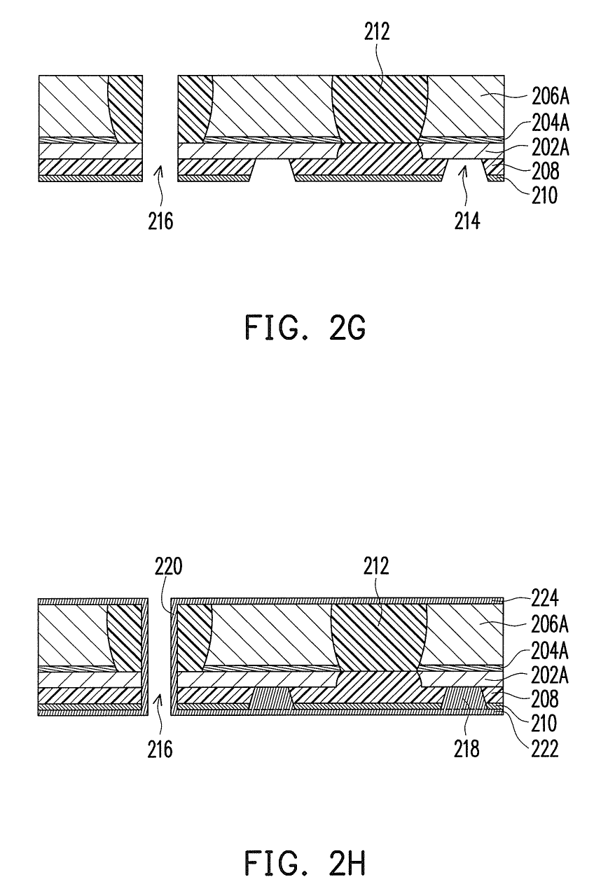

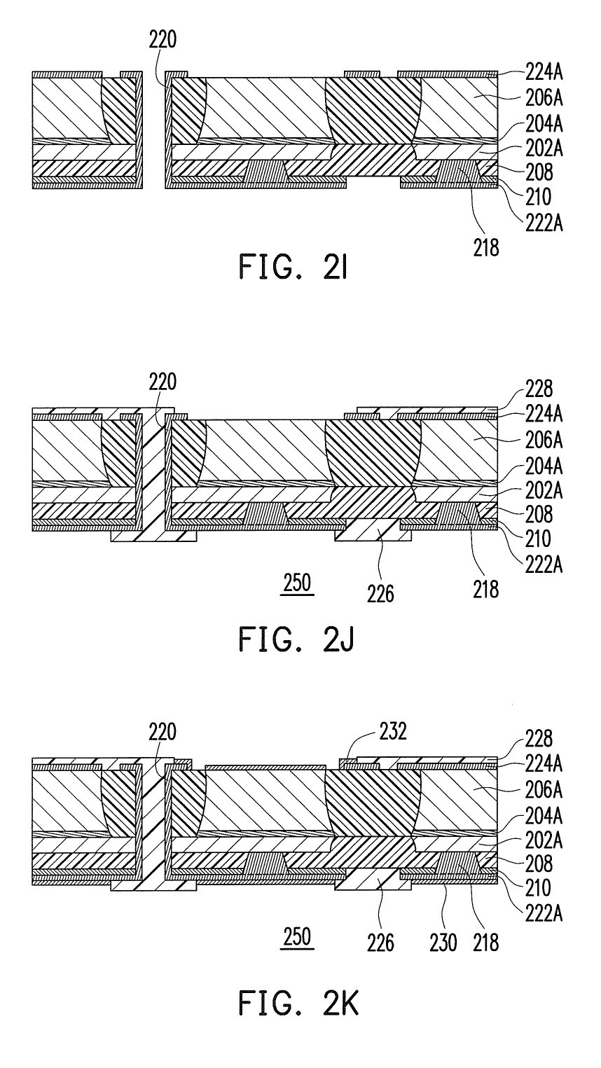

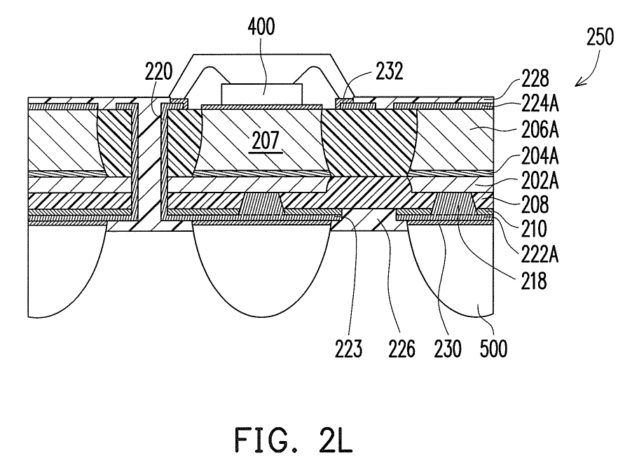

Another embodiment of the present invention regarding a package substrate process will be described below with reference to FIGS. 2A-2L.

Referring to FIG. 2A, a first metal layer 202, a second metal layer 204, and a third metal layer 206 are provided, wherein the second metal layer 204 is between the first metal layer 202 and the third metal layer 206. In the present embodiment, the first metal layer 202 may be a copper layer having its thickness between 12 μm and 50 μm, the second metal layer 204 may be a nickel layer having its thickness between 0.1 μm and 2 μm, and the third metal layer 206 may be a copper layer having its thickness between 50 μm and 400 μm.

Referring to FIG. 2B, the first metal layer 202 is patterned to form a first patterned metal layer 202A and expose part of the surface of the second metal layer 204.

Referring to FIG. 2C, a first dielectric layer 208 is formed in the space surrounded by the first patterned metal layer 202A, and the first dielectric layer 208 covers the exposed surface of the first patterned metal layer 202A. In the present embodiment, the step for forming the first dielectric layer 208 includes following steps. First, a RCC is provided, wherein the RCC includes a resin layer and a copper foil 210 covering one surface of the resin layer. Then, the resin layer is thermo-compressed to be filled into the space surrounded by the first patterned metal layer 202A and the second metal layer 204, and covers the exposed surface of the first patterned metal layer 202A. By now, the first dielectric layer 208 is formed.

Referring to FIG. 2D, the second metal layer 204 and the third metal layer 206 are patterned to form a second patterned metal layer 204A and a third patterned metal layer 206A and expose part of the surface of the first dielectric layer 208.

Referring to FIG. 2E, a second dielectric layer 212 is formed in the spaces surrounded by the second patterned metal layer 204A and the third patterned metal layer 206A. In the present embodiment, a prepreg is thermo-compressed into spaces surrounded by the second patterned metal layer 204A and the third patterned metal layer 206A to form the second dielectric layer 212.

It should be noted that the second dielectric layer 212 formed as described above further covers the exposed surface of the third patterned metal layer 206A. Thus, in the present embodiment, part of the third patterned metal layer 206A and part of the second dielectric layer 212 can be further removed to planarize the third patterned metal layer 206A and the second dielectric layer 212, as shown in FIG. 2F.

Referring to FIG. 2G, at least one opening 214 is formed, wherein the opening 214 is located in the first dielectric layer 208 and exposes part of the exposed surface of the first patterned metal layer 202A. In the present embodiment, the opening 214 may be formed through laser ablation. Besides, the opening 214 is further located in the copper foil 210.

Referring to FIG. 2G again, at least one through hole 216 is formed, wherein the through hole 216 passes through the first dielectric layer 208, the first patterned metal layer 202A, and the second dielectric layer 212. In the present embodiment, the through hole 216 may be formed through mechanical drilling or laser ablation.

Referring to FIG. 2H, a conductive blind via 218 is formed in the opening 214. A conductive through hole 220 is formed in the through hole 216. A fourth metal layer 222 is formed, wherein the fourth metal layer 222 covers the exposed surface of the copper foil 210. A fifth metal layer 224 is formed, wherein the fifth metal layer 224 covers the exposed surface of the second dielectric layer 212. In the present embodiment, the conductive blind via 218, the conductive through hole 220, the fourth metal layer 222, and the fifth metal layer 224 can be formed together through an electroplating process. However, in another embodiment of the present invention, the fourth metal layer 222 can directly cover the exposed surface of the first dielectric layer 208 when the copper foil 210 is skipped.

Referring to FIG. 2I, the fourth metal layer 222 is patterned to form a fourth patterned metal layer 222A. In the present embodiment, the copper foil 210 is also patterned when the fourth metal layer 222 is patterned.

Referring to FIG. 2I again, the fifth metal layer 224 is patterned to form a fifth patterned metal layer 224A. In the present embodiment, the fourth metal layer 222 and the fifth metal layer 224 can be patterned together.

Referring to FIG. 2J, a first patterned solder mask layer 226 is formed, wherein the first patterned solder mask layer 226 covers part of the exposed surface of the first dielectric layer 208 and part of the exposed surface of the fourth patterned metal layer 222A.

Referring to FIG. 2J again, a second patterned solder mask layer 228 is formed, wherein the second patterned solder mask layer 228 covers part of the exposed surface of the third patterned metal layer 206A and part of the exposed surface of the fifth patterned metal layer 224A. Herein, the structure illustrated in FIG. 2J can already serve as a package substrate 250.

Referring to FIG. 2K, at least one first metal surface terminal metallurgy layer 230 is formed, wherein the first metal surface terminal metallurgy layer 230 covers the exposed surface of the fourth patterned metal layer 222A.

Referring to FIG. 2K again, at least one second metal surface terminal metallurgy layer 232 is formed, wherein the second metal surface terminal metallurgy layer 232 covers the exposed surface of the fifth patterned metal layer 224A.

Referring to FIG. 2L, when a chip 400 is packaged to the package substrate 250 through wire bonding, the heat produced by the chip 400 can be directly conducted to the pads 207 formed from the third patterned metal layer 206A. Thus, the heat produced by the chip 400 can be dissipated effectively. In addition, a plurality of conductive bumps 500 may be respectively formed on a plurality of pads 223 formed from the fourth patterned metal layer 222A.

The package substrate fabricated through the process illustrated in FIGS. 2A-2K can be used as a carrier of a QFN package and provide pads arranged as an array. In addition, the present embodiment may also be implemented for fabricating a carrier of a ball grid array (BGA) package, as shown in FIG. 2K.

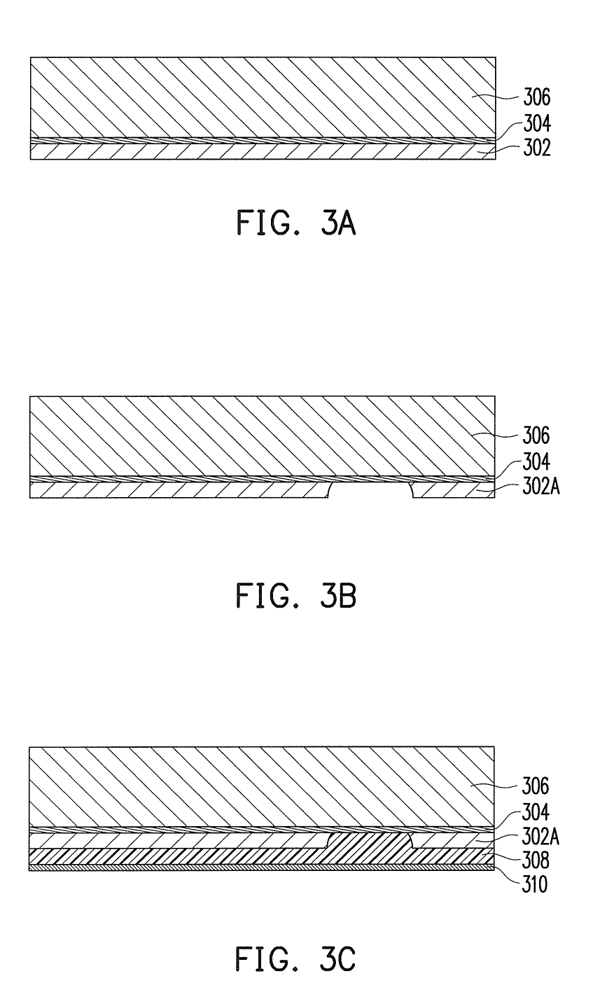

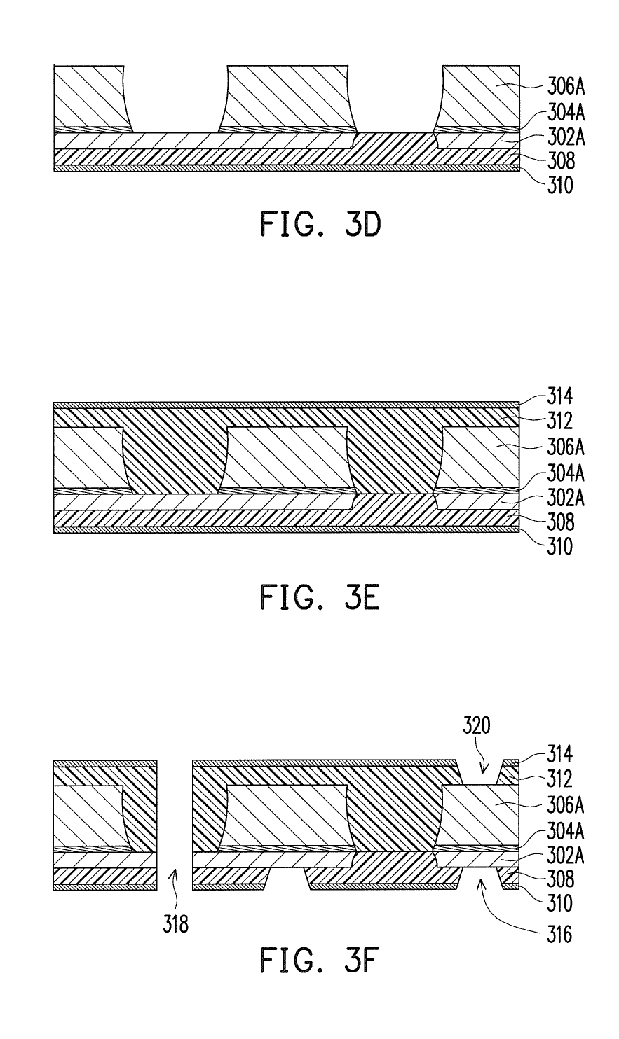

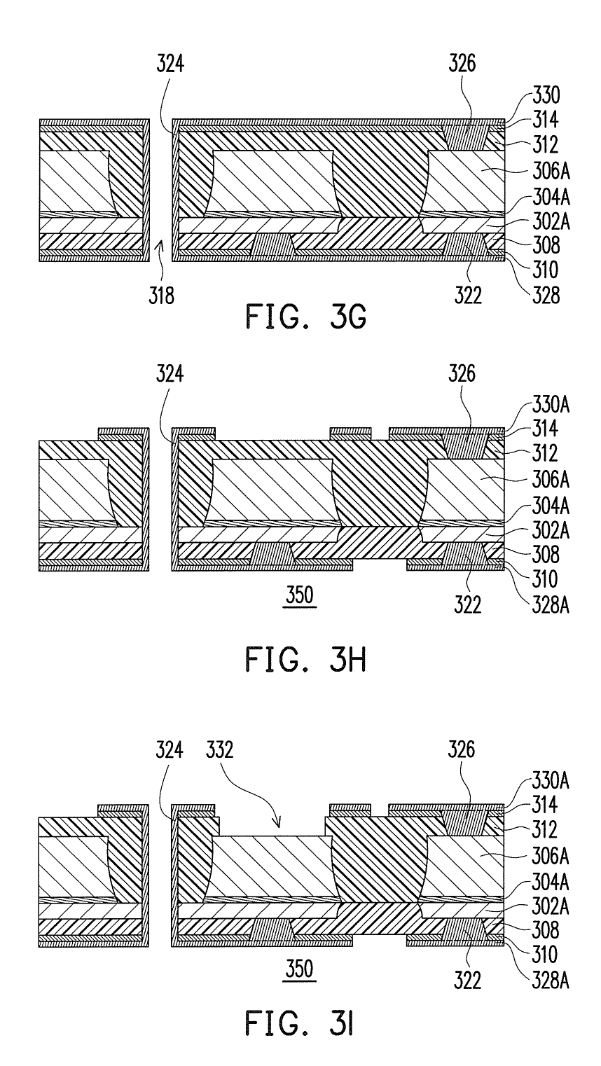

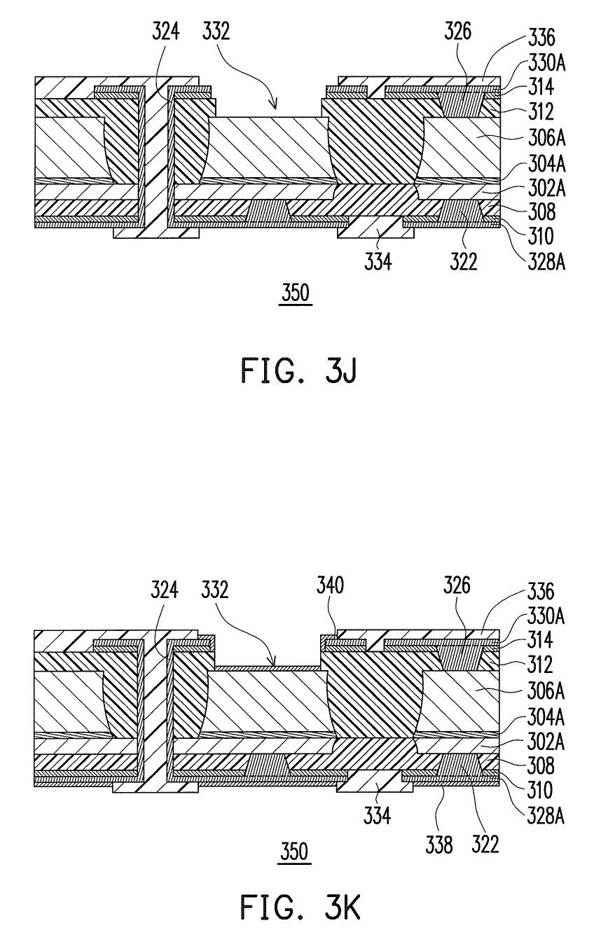

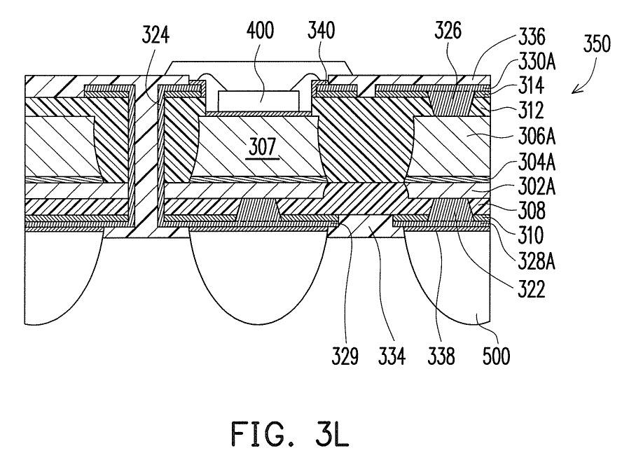

Yet another embodiment of the present invention regarding a package substrate process will be described below with reference to FIGS. 3A-3L.

Referring to FIG. 3A, a first metal layer 302, a second metal layer 304, and a third metal layer 306 are provided, wherein the second metal layer 304 is between the first metal layer 302 and the third metal layer 306. In the present embodiment, the first metal layer 302 may be a copper layer having its thickness between 12 μm and 50 μm, the second metal layer 304 may be a nickel layer having its thickness between 0.1 μm and 2 μm, and the third metal layer 306 may be a copper layer having its thickness between 50 μm and 400 μm.

Referring to FIG. 3B, the first metal layer 302 is patterned to form a first patterned metal layer 302A and expose part of the surface of the second metal layer 304.

Referring to FIG. 3C, a first dielectric layer 308 is formed in the space surrounded by the first patterned metal layer 302A, and the first dielectric layer 308 covers the exposed surface of the first patterned metal layer 302A. In the present embodiment, the step for forming the dielectric layer 308 includes following steps. First, a RCC is provided, wherein the RCC includes a resin layer and a copper foil 310 covering one surface of the resin layer. Then, the resin layer is thermo-compressed to be filled into the space surrounded by the first patterned metal layer 302A and the second metal layer 304, and covers the exposed surface of the first patterned metal layer 302A. By now, the first dielectric layer 308 is formed.

Referring to FIG. 3D, the second metal layer 304 and the third metal layer 306 are patterned to form a second patterned metal layer 304A and a third patterned metal layer 306A and expose part of the surface of the first dielectric layer 308.

Referring to FIG. 3E, a second dielectric layer 312 is formed in the space surrounded by the second patterned metal layer 304A and the third patterned metal layer 306A. In the present embodiment, the step for forming the second dielectric layer 312 includes following steps. First, a RCC is provided, wherein the RCC includes a resin layer and a copper foil 314 covering one surface of the resin layer. Then, the resin layer is thermo-compressed to be filled into the space surrounded by the second patterned metal layer 304A and the third patterned metal layer 306A, and covers the exposed surface of the third patterned metal layer 306A. By now, the second dielectric layer 312 is formed.

Referring to FIG. 3F, at least one first opening 316 is formed, wherein the first opening 316 is located in the first dielectric layer 308 and exposes part of the surface of the first patterned metal layer 302A. In the present embodiment, the first opening 316 may be formed through laser ablation. Besides, the first opening 316 is further located in the copper foil 314.

Referring to FIG. 3F again, at least one through hole 318 is formed, wherein the through hole 318 passes through the first dielectric layer 308, the first patterned metal layer 302A, and the second dielectric layer 312. In the present embodiment, the through hole 318 may be formed through mechanical drilling or laser ablation.

Referring to FIG. 3F again, at least one second opening 320 is formed, wherein the second opening 320 is located in the second dielectric layer 312 and exposes part of the surface of the third patterned metal layer 306A. In the present embodiment, the second opening 320 is further located in the copper foil 314.

Referring to FIG. 3G, a first conductive blind via 322 is formed in the first opening 316. A conductive through hole 324 is formed in the through hole 318. A second conductive blind via 326 is formed in the second opening 320. A fourth metal layer 328 is formed, wherein the fourth metal layer 328 covers the exposed surface of the first dielectric layer 308. A fifth metal layer 330 is formed, wherein the fifth metal layer 330 covers the exposed surface of the second dielectric layer 312. In the present embodiment, the first conductive blind via 322, the conductive through hole 324, the second conductive blind via 326, the fourth metal layer 328, and the fifth metal layer 330 can be formed together through an electroplating process. However, in another embodiment of the present invention, when the copper foil 310 and the copper foil 314 are skipped, the fourth metal layer 328 can directly cover the exposed surface of the first dielectric layer 308, and the fifth metal layer 330 can directly cover the exposed surface of the second dielectric layer 312.

Referring to FIG. 3H, the fourth metal layer 328 is patterned to form a fourth patterned metal layer 328A. In the present embodiment, the copper foil 310 is also patterned when the fourth metal layer 328 is patterned.

Referring to FIG. 3H again, the fifth metal layer 330 is pattern to form a fifth patterned metal layer 330A. In the present embodiment, the copper foil 314 is also patterned when the fifth metal layer 330 is patterned. In addition, in the present embodiment, the fourth metal layer 328 and the fifth metal layer 330 can be patterned together. Herein, the structure illustrated in FIG. 3H can already serve as a package substrate 350.

Referring to FIG. 3I, at least one chip cavity 332 is formed, wherein the chip cavity 332 is located in the second dielectric layer 312. In the present embodiment, the chip cavity 332 may be formed through laser ablation or mechanical blind drilling.

Referring to FIG. 3J, a first patterned solder mask layer 334 is formed, wherein the first patterned solder mask layer 334 covers the exposed surface of the first dielectric layer 308 and part of the exposed surface of the fourth patterned metal layer 328A.

Referring to FIG. 3J again, a second patterned solder mask layer 336 is formed, wherein the second patterned solder mask layer 336 covers part of the exposed surface of the second dielectric layer 312 and part of the exposed surface of the fifth patterned metal layer 330A.

Referring to FIG. 3K, at least one first metal surface terminal metallurgy layer 338 is formed, wherein the first metal surface terminal metallurgy layer 338 covers the exposed surface of the fourth patterned metal layer 328A.

Referring to FIG. 3K again, at least one second metal surface terminal metallurgy layer 340 is formed, wherein the second metal surface terminal metallurgy layer 340 covers the exposed surface of the fifth patterned metal layer 330A.

Referring to FIG. 3L, when a chip 400 is packaged to the package substrate 350 through wire bonding, the heat produced by the chip 400 can be directly conducted to the pads 307 formed from the third patterned metal layer 306A. Thus, the heat produced by the chip 400 can be dissipated effectively. In addition, a plurality of conductive bumps 500 may be respectively formed on a plurality of pads 329 formed from the fourth patterned metal layer 328A.

The package substrate fabricated through the process illustrated in FIG. 3A-3K can be used as a carrier of a QFN package and provide pads arranged as an array. In addition, the present embodiment may be further implemented for fabricating a carrier of a BGA package, as shown in FIG. 3K.

In overview, in the present invention, a plurality of metal layers stacked in sequence is used as a foundation structure for fabricating a package substrate, and a thick heat conductive core is fabricated from one of the metal layers to provide high heat dissipation capability, and a plurality of pads is fabricated from another one of the metal layers for electrically connecting an electronic package at the next level. Moreover, according to the present invention, the pads can be arranged as an array on the bottom of the package substrate. Accordingly, the present invention can provide densely arranged pads.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A package substrate process, comprising:
providing a first metal layer, a second metal layer, and a third metal layer, wherein the second metal layer is between the first metal layer and the third metal layer;
patterning the first metal layer to form a first patterned metal layer and expose parts of a surface of the second metal layer;
forming a dielectric layer in spaces surrounded by the first patterned metal layer, wherein the dielectric layer covers an exposed surface of the first patterned metal layer;
forming at least one opening, wherein the opening is located in the dielectric layer and exposes part of a surface of the first patterned metal layer;
forming a conductive blind via in the opening;
forming a fourth metal layer, wherein the fourth metal layer covers an exposed surface of the dielectric layer;
patterning the fourth metal layer to form a fourth patterned metal layer;
patterning the third metal layer to form a third patterned metal layer;
patterning the second metal layer to form a second patterned metal layer;
forming a first patterned solder mask layer, wherein the first patterned solder mask layer covers an exposed surface of the dielectric layer and part of an exposed surface of the fourth patterned metal layer; and
forming a second patterned solder mask layer, wherein the second patterned solder mask layer covers an exposed surface of the second patterned metal layer and part of an exposed surface of the third patterned metal layer.

2. The package substrate process according to claim 1, wherein the step for forming the dielectric layer comprises:
providing a resin coated copper (RCC), wherein the RCC comprises a resin layer and a copper foil covering one surface of the resin layer; and
thermo-compressing the resin layer to fill the resin layer in spaces surrounded by the first patterned metal layer and the second metal layer and allow the resin layer to cover an exposed surface of the first patterned metal layer, so as to form the dielectric layer.

3. The package substrate process according to claim 2, wherein the opening is further located in the copper foil.

4. The package substrate process according to claim 2, wherein the fourth metal layer further covers an exposed surface of the copper foil.

5. The package substrate process according to claim 2, wherein the copper foil is patterned when the fourth metal layer is patterned.

6. The package substrate process according to claim 1, wherein the step for forming the conductive blind via and the fourth metal layer comprises an electroplating process.

7. The package substrate process according to claim 1 further comprising:
forming at least one first metal surface terminal metallurgy layer, wherein the first metal surface terminal metallurgy layer covers an exposed surface of the fourth patterned metal layer.

8. The package substrate process according to claim 7 further comprising:
forming at least one second metal surface terminal metallurgy layer, wherein the second metal surface terminal metallurgy layer covers an exposed surface of the third patterned metal layer.

9. The packaging substrate process according to claim 8, wherein the terminal metallurgy is a layer of nickel and gold.

10. The package substrate process according to claim 1 further comprising:
forming a reflecting layer, wherein the reflecting layer covers an exposed surface of the second patterned solder mask layer.

11. A package substrate process, comprising:
providing a first metal layer, a second metal layer, and a third metal layer, wherein the second metal layer is between the first metal layer and the third metal layer;
patterning the first metal layer to form a first patterned metal layer and expose part of a surface of the second metal layer;
forming a first dielectric layer in a space surrounded by the first patterned metal layer, wherein the first dielectric layer covers an exposed surface of the first patterned metal layer;
patterning the second metal layer and the third metal layer to form a second patterned metal layer and a third patterned metal layer and expose part of an exposed surface of the first patterned metal layer;
forming a second dielectric layer in spaces surrounded by the second patterned metal layer and the third patterned metal layer;
forming at least one first opening, wherein the first opening is located in the first dielectric layer and exposes part of a surface of the first patterned metal layer;
forming at least one through hole, wherein the through hole passes through the first dielectric layer, the first patterned metal layer, and the second dielectric layer;
forming a first conductive blind via in the first opening;
forming a conductive through hole in the through hole;
forming a fourth metal layer, wherein the fourth metal layer covers an exposed surface of the first dielectric layer;
forming a fifth metal layer, wherein the fifth metal layer covers an exposed surface of the second dielectric layer;
patterning the fourth metal layer to form a fourth patterned metal layer;
patterning the fifth metal layer to form a fifth patterned metal layer;
forming a first patterned solder mask layer, wherein the first patterned solder mask layer covers an exposed surface of the first dielectric layer and part of an exposed surface of the fourth patterned metal layer; and
forming a second patterned solder mask layer, wherein the second patterned solder mask layer covers part of an exposed surface of the second dielectric layer and part of an exposed surface of the fifth patterned metal layer.

12. The package substrate process according to claim 11, wherein the step for forming the first dielectric layer comprises:
providing a RCC, wherein the RCC comprises a resin layer and a copper foil covering one surface of the resin layer; and
thermo-compressing the resin layer to fill the resin layer in a space surrounded by the first patterned metal layer and the second metal layer and allow the resin layer to cover an exposed surface of the first patterned metal layer, so as to form the first dielectric layer.

13. The package substrate process according to claim 12, wherein the first opening is further located in the copper foil.

14. The package substrate process according to claim 12, wherein the fourth metal layer further covers an exposed surface of the copper foil.

15. The package substrate process according to claim 12, wherein the copper foil is patterned when the fourth metal layer is patterned.

16. The package substrate process according to claim 11, wherein the second dielectric layer further covers an exposed surface of the third patterned metal layer.

17. The package substrate process according to claim 16 further comprising:
forming at least one second opening, wherein the second opening is located in the second dielectric layer and exposes part of a surface of the third patterned metal layer.

18. The package substrate process according to claim 17 further comprising:
forming a second conductive blind via in the second opening.

19. The package substrate process according to claim 18, wherein the step for forming the first conductive blind via, the conductive through hole, the second conductive blind via, the fourth metal layer, and the fifth metal layer comprises an electroplating process.

20. The package substrate process according to claim 16, wherein the step for forming the second dielectric layer comprises:
providing a RCC, wherein the RCC comprises a resin layer and a copper foil covering one surface of the resin layer; and
thermo-compressing the resin layer to fill the resin layer in spaces surrounded by the second patterned metal layer and the third patterned metal layer and cover an exposed surface of the third patterned metal layer, so as to form the second dielectric layer.

21. The package substrate process according to claim 20, wherein the second opening is further located in the copper foil.

22. The package substrate process according to claim 20, wherein the fifth metal layer further covers an exposed surface of the copper foil.

23. The package substrate process according to claim 20, wherein the copper foil is patterned when the fifth metal layer is patterned.

24. The package substrate process according to claim 16 further comprising:
forming at least one chip cavity, wherein the chip cavity is located in the second dielectric layer.

25. The package substrate process according to claim 11, wherein the step for forming the first conductive blind via, the conductive through hole, the fourth metal layer, and the fifth metal layer comprises an electroplating process.

26. The package substrate process according to claim 11 further comprising:
forming at least one first metal surface terminal metallurgy layer, wherein the first metal surface terminal metallurgy layer covers an exposed surface of the fourth patterned metal layer.

27. The package substrate process according to claim 25 further comprising:
forming at least one second metal surface terminal metallurgy layer, wherein the second metal surface terminal metallurgy layer covers an exposed surface of the third patterned metal layer.

28. The packaging substrate process according to claim 27, wherein the terminal metallurgy is a layer of nickel and gold.
